(19) United States
(12) Patent Application Publication
(10) Pub. No.: US 2023/0211560 A1
(43) Pub. Date: Jul. 6, 2023

(54) COGNITIVE PATTERN CHOREOGRAPHER

(71) Applicant: INTERNATIONAL BUSINESS MACHINES CORPORATION, ARMONK, NY (US)

(72) Inventors: Craig M. Trim, Ventura, CA (US); Hernan A. Cunico, Holly Springs, NC (US); Shikhar Kwatra, San Jose, CA (US); Aaron K. Baughman, Cary, NC (US)

(21) Appl. No.: 17/647,058

(22) Filed: Jan. 5, 2022

(51) Int. Cl. B29C 64/386; G06F 16/9035; G06V 40/20; G06F 40/20; G06F 3/01

(52) U.S. Cl. CPC B29C 64/386; G06F 16/9035; G06V 40/20; G06F 40/20; G06F 3/01; B33Y 50/02

(57) ABSTRACT

According to one embodiment, a method, computer system, and computer program product for three-dimensional printing is provided. The embodiment may include analyzing data of a user. The data is collected while the user is performing an activity. The embodiment may include deriving a user behavior model (UBM) of the user based on the analysis of the data. The embodiment may include calculating a relative comfort coefficient (RCC) of the user for the activity based on attributes of the UBM. The embodiment may include predicting adjustments to the attributes of the UBM which result in the RCC exceeding a threshold value. The predicted adjustments are derived using a convolutional neural network classifier. The embodiment may include defining one or more parameters of a tangible component of an object utilized by the user when performing the activity based on the predicted adjustments.

### BACKGROUND

The present invention relates generally to the field of computing, and more particularly to three-dimensional printing.

Three-dimensional (3D) printing, or additive manufacturing, is the construction of a three-dimensional solid object from a digital file (e.g., a computer-aided design model or a digital 3D model). 3D printing may refer to a variety of processes in which material is deposited, joined, or solidified under computer control to create a 3D object using a series of additive or layered development framework, where layers are laid down in succession to create the complete 3D object. Each of the layers may be seen as a thinly sliced cross-section of the object. 3D printing is an alternative to traditional product manufacturing processes where objects are designed by cutting and forcibly shaping raw material through the use of molds and dies. A key advantage of 3D printing is the ability to produce complex shapes or geometries which would be otherwise impossible to construct by hand. 3D printing encompasses many forms of technology and materials. As such, 3D printing is increasingly used across many industries and applications, including end-use 3D printed consumer products.

### SUMMARY

According to one embodiment, a method, computer system, and computer program product for three-dimensional printing is provided. The embodiment may include analyzing data of a user. The data is collected while the user is performing an activity. The embodiment may include deriving a user behavior model (UBM) of the user based on the analysis of the data. The embodiment may include calculating a relative comfort coefficient (RCC) of the user for the activity based on attributes of the UBM. The embodiment may include predicting adjustments to the attributes of the UBM which result in the RCC exceeding a threshold value. The predicted adjustments are derived using a convolutional neural network classifier. The embodiment may include defining one or more parameters of a tangible component of an object utilized by the user when performing the activity based on the predicted adjustments.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for increasing user comfort in a three-dimensional printing process according to at least one embodiment.

FIG. 3 is a functional block diagram of internal and external components of computers and servers depicted in FIG. 1 according to at least one embodiment.

FIG. 4 depicts a cloud computing environment according to an embodiment of the present invention.

FIG. 5 depicts abstraction model layers according to an embodiment of the present invention.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

The present invention relates generally to the field of computing, and more particularly to three-dimensional (3D) printing. The following described exemplary embodiments provide a system, method, and program product to, among other things, analyze data relating to comfort of a user while performing an activity, identify one or more proposed comfort increasing alterations to one or more components of an object used by the user in performance of the activity, and accordingly, create one or more altered components of the object via a 3D printer. Therefore, the present embodiment has the capacity to improve the technical field of 3D printing by dynamically creating variations of components of objects, utilized by a user in execution of an activity, based on a comfort analysis of the user, thus increasing the comfort, and thereby the performance, of the user in execution of the activity.

As previously described, 3D printing, or additive manufacturing, is the construction of a three-dimensional solid object from a digital file (e.g., a computer-aided design model or a digital 3D model). 3D printing may refer to a variety of processes in which material is deposited, joined, or solidified under computer control to create a 3D object using a series of additive or layered development framework, where layers are laid down in succession to create the complete 3D object. Each of the layers may be seen as a thinly sliced cross-section of the object. 3D printing is an alternative to traditional product manufacturing processes where objects are designed by cutting and forcibly shaping raw material through the use of molds and dies. A key advantage of 3D printing is the ability to produce complex shapes or geometries which would be otherwise impossible to construct by hand. 3D printing encompasses many forms of technology and materials. As such, 3D printing is increasingly used across many industries and applications, including end-use 3D printed consumer products.

Performance may be directly linked to the comfort level of a user involved in an activity. These activities can widely vary from driving a car, to sitting down while participating in a meeting or performing some work-related task, to walking/running, to sleeping. Nevertheless, it may be presumed that the more comfortable the user is while executing an activity, the higher the likelihood to maximize the performance of the user in execution of the associated activity. Moreover, components of an object utilized by the user when performing an activity (e.g., car tires, a chair, shoes/sneakers, a mattress) may influence the comfort experienced by the user. However, traditional manufacturing processes are typically limited to standard sizes or structures for objects intended for use by a plurality of users. For example, in the context of car tires, a manufacturer may offer a comfort ride or performance/sport ride with variations for all terrain, highway, and snow. While these options refer to the tread and stiffness of a tire and its expected relative performance on specific road conditions, there is limited variation to choose from and none of these options are specifically tailored to a user. The same may be said of insoles for shoes/sneakers and cushions for chairs or other furniture. It may therefore be imperative to have a system in place to analyze data of a user while performing an activity in order to identify individual drivers of performance based on a comfort level of the user and utilize information of identified drivers of performance to 3D print one or more internal structures, of an object utilized by the user while performing the activity, which result in a custom-tailored design and increased comfort for the user. Thus, embodiments of the present invention may be advantageous to, among other things, identifying metrics that are related to cognitive performance based on user comfort, predicting the demand of cognitive driven performance indicators required to maximize user comfort and performance in an activity, and identifying micro-based adjustments to structural patterns of a 3D printed object to arrive at an adjustment tailored to a user. The present invention does not require that all advantages need to be incorporated into every embodiment of the invention.

According to at least one embodiment, when a user is performing an activity, data relating to a state of the user while performing the activity may be received. Contextual analysis of the received data may be performed, and a resulting user behavior model may be created which includes derived metrics and a quantified comfort level associated with the user's performance of the activity. The user behavior model may be used to predict one or more adjustments to the derived metrics which increase the quantified comfort level associated with the user's performance of the activity. The predicted adjustments may be mapped to proposed adjustments to parameters of one or more components of an object utilized by the user when performing the activity, and the one or more components may be created, via 3D printing, according to the proposed adjusted parameters.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The following described exemplary embodiments provide a system, method, and program product to identify individual drivers of user performance based on a comfort level of the user when performing an activity and derive adjusted patterns for 3D printing of components, of an object utilized by the user when performing the activity, that result in a personalized object for the user which increases comfort when executing the activity, and thereby increases user performance during the activity.

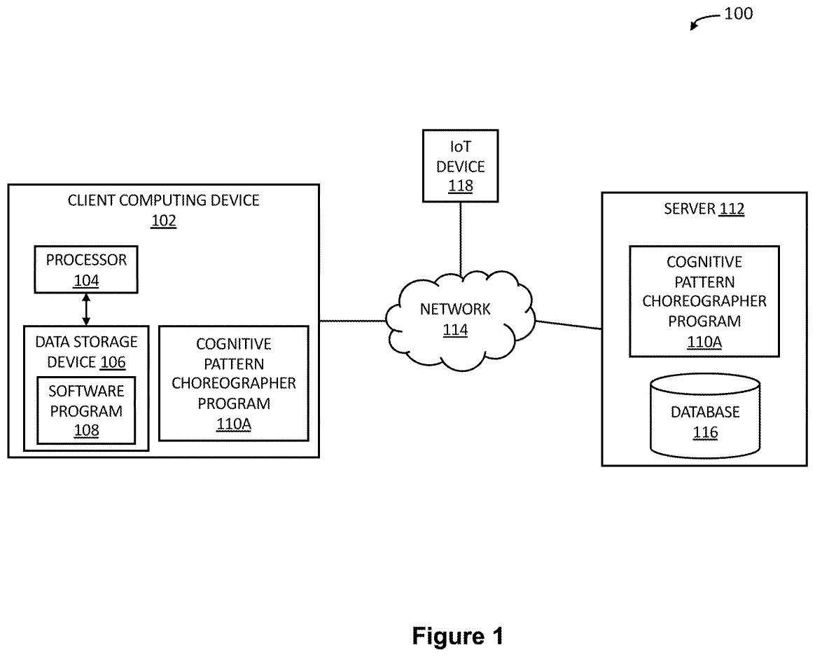

Referring to FIG. 1, an exemplary networked computer environment 100 is depicted, according to at least one embodiment. The networked computer environment 100 may include a client computing device 102, a server 112, and Internet of Things (IoT) Device 118 interconnected via a communication network 114. According to at least one implementation, the networked computer environment 100 may include a plurality of client computing devices 102, servers 112, and IoT devices 118, of which only one of each is shown for illustrative brevity. Additionally, in one or more embodiments, the client computing device 102 and the server 112 may each host a cognitive pattern choreographer (CPC) program 110A, 110B. In one or more other embodiments, the CPC program 110A, 110B may be partially hosted on client computing device 102 and server 112 so that functionality may be separated among the devices.

The communication network 114 may include various types of communication networks, such as a wide area network (WAN), local area network (LAN), a telecommunication network, a wireless network, a public switched network and/or a satellite network. The communication network 114 may include connections, such as wired or wireless communication links or fiber optic cables. It may be appreciated that FIG. 1 provides only an illustration of one implementation and does not imply any limitations with regard to the environments in which different embodiments may be implemented. Many modifications to the depicted environments may be made based on design and implementation requirements.

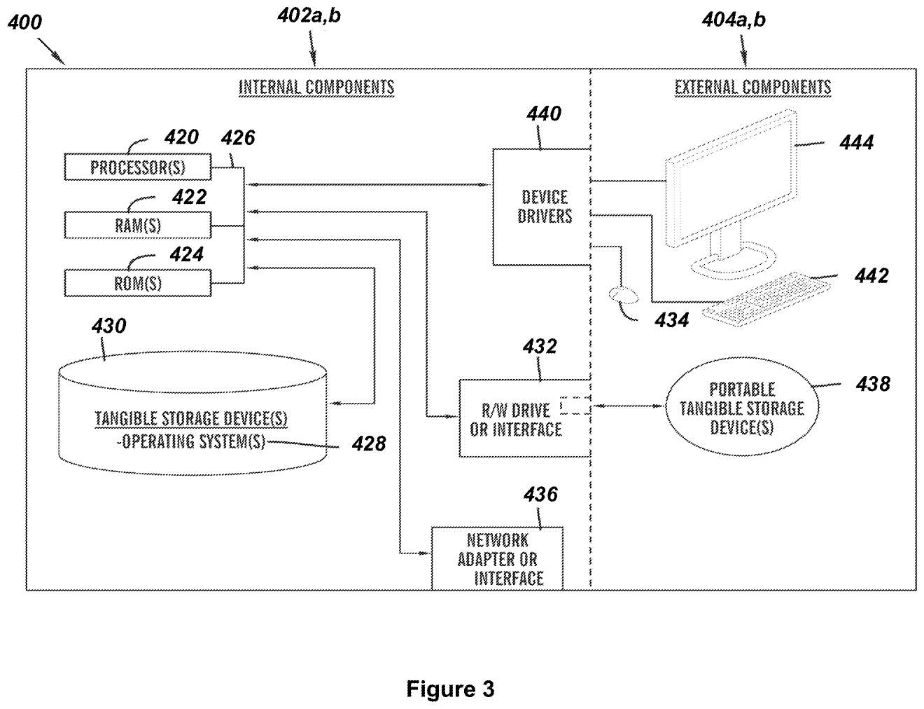

Client computing device 102 may include a processor 104 and a data storage device 106 that is enabled to host and run a software program 108 and a CPC program 110A and communicate with the server 112 and IoT device 118 via the communication network 114, in accordance with one embodiment of the invention. Client computing device 102 may be, for example, a mobile device, a telephone, a personal digital assistant, a netbook, a laptop computer, a tablet computer, a desktop computer, or any type of computing device capable of running a program and accessing a network. As will be discussed with reference to FIG. 3, the client computing device 102 may include internal components 402a and external components 404a, respectively.

The server computer 112 may be a laptop computer, netbook computer, personal computer (PC), a desktop computer, or any programmable electronic device or any network of programmable electronic devices capable of hosting and running a CPC program 110B and a database 116 and communicating with the client computing device 102 and IoT device 118 via the communication network 114, in accordance with embodiments of the invention. As will be discussed with reference to FIG. 3, the server computer 112 may include internal components 402b and external components 404b, respectively. The server 112 may also operate in a cloud computing service model, such as Software as a Service (SaaS), Platform as a Service (PaaS), or Infrastructure as a Service (IaaS). The server 112 may also be located in a cloud computing deployment model, such as a private cloud, community cloud, public cloud, or hybrid cloud.

IoT device 118 may be a camera, a global positioning system (GPS) device, a microphone, a wearable computing device, a heartrate monitor, smart fabric, a smartphone, a smartwatch, and any other IoT device 118 known in the art for capturing image data, sound data, location data, biometric data, and/or pressure data of a user, capable of connecting to the communication network 114, and transmitting and receiving data with the client computing device 102 and the server 112. Furthermore, IoT device 118 may have one or more sound sensors, motion sensors, or pressure sensors internally embedded or externally connected to allow for the capture of sound data, movement data, or biometric data of the user. According to at least one embodiment, IoT device 118 may be embedded within or attached to the client computing device 102. Additionally, IoT device 118 may be a 3D printer capable of connecting to the communication network 114 and receiving data from the client computing device 102 and the server 112. As previously described, one IoT device 118 is depicted in FIG. 1 for illustrative purposes, but many IoT devices 118 may be connected via network 114.

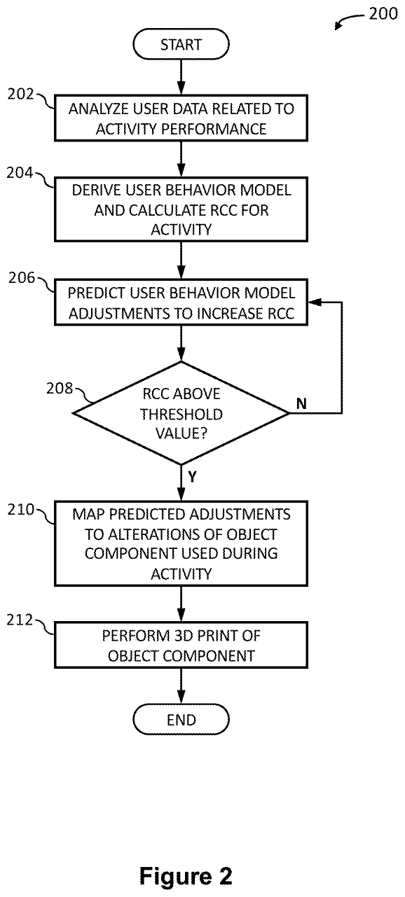

According to the present embodiment, the CPC program 110A, 110B may be a program capable of analyzing data of a user gathered while the user is performing an activity, creating a user behavior model based on the analyzed data, calculating a relative comfort coefficient associated with the user's performance of the activity, predicting adjustments to the user behavior model which increase the relative comfort coefficient of the user, mapping predicted adjustments to adjustments of one or more components of an object utilized by the user when performing the activity, and causing the 3D printing of one or more adjusted components. In at least one embodiment, the CPC program 110A, 110B may require each user to opt-in to system usage upon opening or installation of the CPC program 110A, 110B. In at least one other embodiment, the CPC program 110A, 110B may be incorporated as a plug-in to another software application (e.g., as a plug-in to productivity software). The CPC method is explained in further detail below with respect to FIG. 2.

Referring now to FIG. 2, an operational flowchart for increasing user performance based on user comfort analysis in a 3D printing process 200 is depicted according to at least one embodiment. At 202, the CPC program 110A, 110B analyzes received data collected while the user was performing one or more activities and derives a context for each activity. The data may be collected by one or more smart devices (e.g., IoT device 118) which may have monitored the user, as well as an environment of the user, and stored data relating to a physical and/or emotional state of the user in the context of an activity being performed by the user. The data may include, for example, captured images, observed movement, captured audio, captured text, and measured biometric data of the user and/or the user's environment. The data may also include digital calendar information of the user and information of applications (e.g., software program 108) involved in performance of the activity, which is accessible by the CPC program 110A, 110B. Additionally, in embodiments where the CPC program 110A, 110B is incorporated within another software application, the data may also include information relating to use of the incorporating application by the user. The CPC program 110A, 110B may apply known analysis techniques to the data which may include, but are not limited to, image analysis and one or more sentiment analyses derived from verbal, text, and body language analysis of the user. The CPC program 110A, 110B may also apply a combination of natural language processing (NLP) (e.g., tone analysis and sentiment analysis), entity, and corpus linguist methods to captured text and audio data to derive core elements and a context of the performed activity and the user's behavioral response, and then cluster and categorize the elements using a Gaussian mixture model. Physical and biometric data may also be captured and categorized. The collected data may be stored within data storage device 106 or database 116 and received from software program 108.

Next, at 204, the CPC program 110A, 110B creates a user behavior model (UBM) of the user based on the data analysis performed in step 202. The UBM may include the following derived components/attributes which are associated with the activity performed by the user: an activity type, a complexity of the activity, an importance of the activity to the user, a topic, a category, one or more sentiment coefficients of the user, a participation coefficient of the user, and a relative movement coefficient of the user. It should be noted that the CPC program 110A, 110B may derive a separate set of the aforementioned components/attributes for every activity performed by the user. The derived coefficients may be represented as numbers (e.g., zero to one, one to ten) or percentages which may be manipulated and compared against each other. The CPC program 110A, 110B may then utilize Barnard's or Fisher's test to identify dependencies or independencies between the derived components/attributes and between existing external factors which are out of the context of the activity being analyzed. Existing external factors which are out of the context of the activity being analyzed may be filtered out of further analysis by the CPC program 110A, 110B. The UBM may be used to infer a response/behavior of the user in the context of the activity being performed by the user, and to identify potential objects, utilized by the user in performance of the activity, which may be influencing the response/behavior of the user. For example, from data of the UBM, the CPC program 110A, 110B may infer that the user is walking/running in the context of an exercise activity. Moreover, NLP of captured audio of the user, image analysis of the user, or biometric data of the user while performing the exercise activity may have indicated the pair of shoes being worn by the user as a source of negative sentiment or frustration and poor movement or discomfort for the user due to insufficient arch support or cushioning.

Additionally, at 204 the CPC program 110A, 110B calculates a relative comfort coefficient (RCC) of the user for the activity being performed. The RCC may be calculated as a function of the complexity (c) of the activity, the importance (i) of the activity to the user, one or more sentiment coefficients (s) of the user, the participation coefficient (p) of the user, and the relative movement coefficient (m) of the user. As such, the RCC of the user for a particular activity may change in response to increases or decreases in the inputs c, i, s, p, and m. It should be noted that the CPC program 110A, 110B may calculate a separate RCC for every activity performed by the user. From the UBM, the CPC program 110A, 110B may identify the drivers (i.e., the derived components/attributes) that influence the behavioral response of the user to the activity being performed, and subsequently influence the RCC of the user for that activity. Identification of drivers, and their context, which negatively influence or reduce the RCC (e.g., a negative or low sentiment coefficient) may be of particular interest as these may be areas for potential adjustment by the CPC program 110A, 110B. In continuation of the previous example, negative sentiment and relative movement coefficients resulting from the user's expressed discomfort with their shoes may be identified by the CPC program 110A, 110B as drivers which are adversely influencing (e.g., reducing value) a calculated RCC of the user for the exercise activity.

At 206, the CPC program 110A, 110B predicts adjustments to components/attributes of the UBM which may result in an increased comfort level of the user when performing the activity. More specifically, the CPC program 110A, 110B derives predicted adjustments to one or more inputs of the RCC which may result in an increased RCC of the user for the activity. In identifying correct adjustments which increase the RCC, the CPC program 110A, 110B may implement a reinforcement learning model infused with a convolutional neural network (CNN) classifier which may iterate on variations (e.g., increments or decrements) to one or more inputs of the RCC. As such, the CPC program 110A, 110B may learn from every adjustment prediction and update a reward function in the case of a correct prediction, that is, a prediction which increases the RCC of the user for the activity. The reward function may be directly proportional to the RCC, consequently, a reward value of +x is provided to the model in case of an increased RCC and a reward value of −x is provided to the model in case of a decreased RCC. Continuing with the ongoing example, out of step 204, the CPC program 110A, 110B identified the sentiment and relative movement coefficient inputs to the RCC as having a negative or decreasing effect. In response, the CPC program 110A, 110B may, in step 206, predict and apply incremental adjustments to the sentiment and relative movement coefficient inputs (e.g., increase their value) and observe the effect of each adjustment on the RCC of the user for the exercise activity, with the goal of increasing the RCC to exceed a user defined threshold value or to reach a global maximum.

Next, at 208, the CPC program 110A, 110B determines whether the RCC of the user for the activity exceeds the user defined threshold value or has reached the global maxima as a result of the correctly predicted adjustments of one or more inputs to the RCC. In response to determining that the RCC of the user for the activity exceeds the user defined threshold value or has reached the global maxima (step 208, “Y” branch), the 3D printing process 200 may proceed to step 210. In response to determining that the RCC of the user for the activity does not exceed the user defined threshold value or has not reached the global maxima (step 208, “N” branch), the 3D printing process 200 may return to step 206.

At 210, the CPC program 110A, 110B maps correctly predicted adjustments to one or more inputs of the RCC of the user for the activity being performed to one or more tangible components of an object utilized by the user when performing the activity. In doing so, the CPC program 110A, 110B may analyze the type of activity being performed in order to first identify components associated with the activity and then identify if one or more of those components are tangible structures which may be altered. The CPC program 110A, 110B may utilize received contextual data of the user and the activity being performed as well as data of the UBM when analyzing the activity. The CPC program 110A, 110B may cluster different activities as part of K-means clustering depending on the Euclidian distance of certain tasks and using a cosine similarity metric as part of computing a similarity angle. Hence, activities are broken down based on identifying an individual user's task at hand which are associated with a particular user. Out of step 210, the CPC program 110A, 110B defines one or more parameters of proposed modifications to the one or more tangible components of the object utilized by the user when performing the activity. The proposed modifications may be mapped to the correctly predicted adjustments of the one or more inputs of the RCC such that implementation of the proposed modifications may achieve, in a future performance of the activity by the user, the desired adjustments to the one or more inputs of the RCC and thus achieve the RCC value which exceeds the user defined threshold value or reaches the global maxima. In furtherance of the ongoing example, the CPC program 110A, 110B may analyze the exercise activity being performed and identify shoe insoles as tangible components associated with the exercise activity which may be altered. Accordingly, the CPC program 110A, 110B may define parameters for alterations to the shoe insoles (e.g., parameters which increase arch support or cushioning) which may actualize the correctly predicted adjustments to the sentiment and relative movement coefficient inputs which resulted in a maximized RCC of the user for the exercise activity.

Next, at 212, the CPC program 110A, 110B causes the 3D printing of the one or more tangible components according to the defined parameters of the proposed modifications. More specifically, the CPC program 110A, 110B may direct the 3D printing of the one or more tangible components according to the defined parameters of the proposed modifications by an accessible 3D printer (e.g., IoT device 118). In conclusion of the ongoing example, the CPC program 110A, 110B may direct the 3D printing of the shoe insoles according to the defined parameters which increase arch support or cushioning of the insoles.

According to at least one further embodiment, the CPC program 110A, 110B may compile and analyze a large volume of user data relating to activity performance. The large volume of user data may be accessible from cloud storage (e.g., from database 116 of server 112). From analysis of the large volume of user data relating to activity performance, the CPC program 110A, 110B may generalize user types and activity types and, accordingly, produce abstractions for specific activities or biometric cluster instances (i.e., user types). In particular, although not exclusively, abstractions of those clusters that scored higher ratios in comfort/activity dependency and relevancy over given period of time. The CPC program 110A, 110B may then use the generalized cluster model to derive one or more generic UBMs that may be applied to disparate sets of conditions/activities or users.

It may be appreciated that FIG. 2 provides only an illustration of one implementation and do not imply any limitations with regard to how different embodiments may be implemented. Many modifications to the depicted environments may be made based on design and implementation requirements.

FIG. 3 is a block diagram 400 of internal and external components of the client computing device 102 and the server 112 depicted in FIG. 1 in accordance with an embodiment of the present invention. It should be appreciated that FIG. 3 provides only an illustration of one implementation and does not imply any limitations with regard to the environments in which different embodiments may be implemented. Many modifications to the depicted environments may be made based on design and implementation requirements.

The data processing system 402, 404 is representative of any electronic device capable of executing machine-readable program instructions. The data processing system 402, 404 may be representative of a smart phone, a computer system, PDA, or other electronic devices. Examples of computing systems, environments, and/or configurations that may represented by the data processing system 402, 404 include, but are not limited to, personal computer systems, server computer systems, thin clients, thick clients, hand-held or laptop devices, multiprocessor systems, microprocessor-based systems, network PCs, minicomputer systems, IoT devices, and distributed cloud computing environments that include any of the above systems or devices.

The client computing device 102 and the server 112 may include respective sets of internal components 402a,b and external components 404a,b illustrated in FIG. 3. Each of the sets of internal components 402 include one or more processors 420, one or more computer-readable RAMs 422, and one or more computer-readable ROMs 424 on one or more buses 426, and one or more operating systems 428 and one or more computer-readable tangible storage devices 430. The one or more operating systems 428, the software program 108 and the CPC program 110A in the client computing device 102, and the CPC program 110B in the server 112 are stored on one or more of the respective computer-readable tangible storage devices 430 for execution by one or more of the respective processors 420 via one or more of the respective RAMs 422 (which typically include cache memory). In the embodiment illustrated in FIG. 3, each of the computer-readable tangible storage devices 430 is a magnetic disk storage device of an internal hard drive. Alternatively, each of the computer-readable tangible storage devices 430 is a semiconductor storage device such as ROM 424, EPROM, flash memory or any other computer-readable tangible storage device that can store a computer program and digital information.

Each set of internal components 402a,b also includes a RAY drive or interface 432 to read from and write to one or more portable computer-readable tangible storage devices 438 such as a CD-ROM, DVD, memory stick, magnetic tape, magnetic disk, optical disk or semiconductor storage device. A software program, such as the CPC program 110A, 110B, can be stored on one or more of the respective portable computer-readable tangible storage devices 438, read via the respective R/W drive or interface 432, and loaded into the respective hard drive 430.

Each set of internal components 402a,b also includes network adapters or interfaces 436 such as a TCP/IP adapter cards, wireless Wi-Fi interface cards, or 3G or 4G wireless interface cards or other wired or wireless communication links. The software program 108 and the CPC program 110A in the client computing device 102 and the CPC program 110B in the server 112 can be downloaded to the client computing device 102 and the server 112 from an external computer via a network (for example, the Internet, a local area network or other, wide area network) and respective network adapters or interfaces 436. From the network adapters or interfaces 436, the software program 108 and the CPC program 110A in the client computing device 102 and the CPC program 110B in the server 112 are loaded into the respective hard drive 430. The network may comprise copper wires, optical fibers, wireless transmission, routers, firewalls, switches, gateway computers and/or edge servers.

Each of the sets of external components 404a,b can include a computer display monitor 444, a keyboard 442, and a computer mouse 434. External components 404a,b can also include touch screens, virtual keyboards, touch pads, pointing devices, and other human interface devices. Each of the sets of internal components 402a,b also includes device drivers 440 to interface to computer display monitor 444, keyboard 442, and computer mouse 434. The device drivers 440, R/W drive or interface 432, and network adapter or interface 436 comprise hardware and software (stored in storage device 430 and/or ROM 424).

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

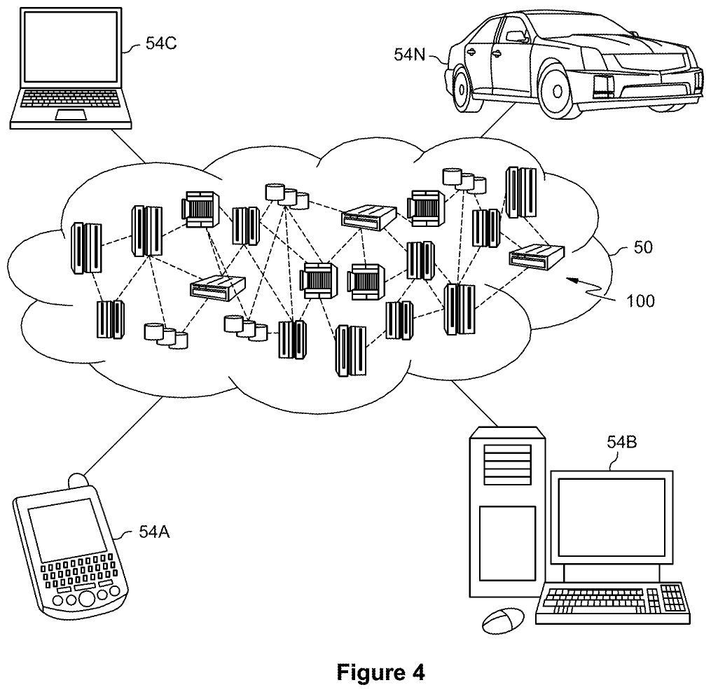

Referring now to FIG. 4, illustrative cloud computing environment 50 is depicted. As shown, cloud computing environment 50 comprises one or more cloud computing nodes 100 with which local computing devices used by cloud consumers, such as, for example, personal digital assistant (PDA) or cellular telephone 54A, desktop computer 54B, laptop computer 54C, and/or automobile computer system 54N may communicate. Nodes 100 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 100 and cloud computing environment 50 can communicate with any type of computerized device over any type of network and/or network addressable connection (e.g., using a web browser).

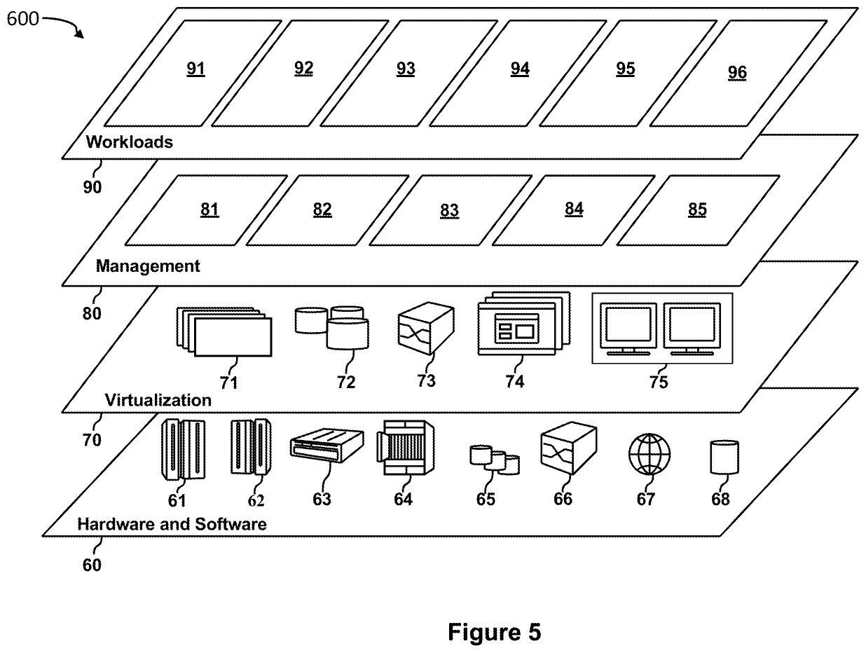

Referring now to FIG. 5, a set of functional abstraction layers 600 provided by cloud computing environment 50 is shown. It should be understood in advance that the components, layers, and functions shown in FIG. 5 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and cognitive pattern choreographer 96. Cognitive pattern choreographer 96 may relate to the 3D printing of a component of an object based on a comfort level of a user of the object.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, the method comprising:
analyzing data of a user, wherein the data is collected while the user is performing an activity;
deriving a user behavior model (UBM) of the user based on the analysis of the data;
calculating a relative comfort coefficient (RCC) of the user for the activity based on attributes of the UBM;
predicting adjustments to the attributes of the UBM which result in the RCC exceeding a threshold value, wherein the predicted adjustments are derived using a convolutional neural network classifier; and
defining one or more parameters of a tangible component of an object utilized by the user when performing the activity based on the predicted adjustments.

2. The method of claim 1, further comprising:
causing a three-dimensional printing of the tangible component according to the defined one or more parameters.

3. The method of claim 1, further comprising:
analyzing a large volume of user data relating to activity performance;
generalizing one or more user types and one or more activity types based on the analysis; and
deriving one or more generic UBMs which may be applied to disparate sets of activities or users.

4. The method of claim 1, wherein data of the user is received from one or more Internet-of-Things devices which monitored the user, as well as an environment of the user, and stored data relating to a physical or emotional state of the user in the context of the activity being performed by the user.

5. The method of claim 1, wherein attributes of the UBM comprise an element from the group consisting of an activity type, a complexity of the activity, an importance of the activity to the user, a topic, a category, one or more sentiment coefficients of the user, a participation coefficient of the user, and a relative movement coefficient of the user.

6. The method of claim 5, wherein the RCC of the user for the activity is calculated as a function of the complexity of the activity, the importance of the activity to the user, the one or more sentiment coefficients of the user, the participation coefficient of the user, and the relative movement coefficient of the user.

7. The method of claim 1, wherein the data of the user comprises an element from the group consisting of captured images, observed movement, captured audio, captured text, and measured biometric data of the user or the user's environment, and wherein analysis of the data of the user comprises image analysis, sentiment analysis, and natural language processing.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
analyzing data of a user, wherein the data is collected while the user is performing an activity;
deriving a user behavior model (UBM) of the user based on the analysis of the data;
calculating a relative comfort coefficient (RCC) of the user for the activity based on attributes of the UBM;
predicting adjustments to the attributes of the UBM which result in the RCC exceeding a threshold value, wherein the predicted adjustments are derived using a convolutional neural network classifier; and
defining one or more parameters of a tangible component of an object utilized by the user when performing the activity based on the predicted adjustments.

9. The computer system of claim 8, further comprising:
causing a three-dimensional printing of the tangible component according to the defined one or more parameters.

10. The computer system of claim 8, further comprising:
analyzing a large volume of user data relating to activity performance;
generalizing one or more user types and one or more activity types based on the analysis; and
deriving one or more generic UBMs which may be applied to disparate sets of activities or users.

11. The computer system of claim 8, wherein data of the user is received from one or more Internet-of-Things devices which monitored the user, as well as an environment of the user, and stored data relating to a physical or emotional state of the user in the context of the activity being performed by the user.

12. The computer system of claim 8, wherein attributes of the UBM comprise an element from the group consisting of an activity type, a complexity of the activity, an importance of the activity to the user, a topic, a category, one or more sentiment coefficients of the user, a participation coefficient of the user, and a relative movement coefficient of the user.

13. The computer system of claim 12, wherein the RCC of the user for the activity is calculated as a function of the complexity of the activity, the importance of the activity to the user, the one or more sentiment coefficients of the user, the participation coefficient of the user, and the relative movement coefficient of the user.

14. The computer system of claim 8, wherein the data of the user comprises an element from the group consisting of captured images, observed movement, captured audio, captured text, and measured biometric data of the user or the user's environment, and wherein analysis of the data of the user comprises image analysis, sentiment analysis, and natural language processing.

15. A computer program product, the computer program product comprising:
one or more computer-readable tangible storage medium and program instructions stored on at least one of the one or more tangible storage medium, the program instructions executable by a processor capable of performing a method, the method comprising:
analyzing data of a user, wherein the data is collected while the user is performing an activity;
deriving a user behavior model (UBM) of the user based on the analysis of the data;
calculating a relative comfort coefficient (RCC) of the user for the activity based on attributes of the UBM;
predicting adjustments to the attributes of the UBM which result in the RCC exceeding a threshold value, wherein the predicted adjustments are derived using a convolutional neural network classifier; and
defining one or more parameters of a tangible component of an object utilized by the user when performing the activity based on the predicted adjustments.

16. The computer program product of claim 15, further comprising:
causing a three-dimensional printing of the tangible component according to the defined one or more parameters.

17. The computer program product of claim 15, further comprising:
analyzing a large volume of user data relating to activity performance;
generalizing one or more user types and one or more activity types based on the analysis; and
deriving one or more generic UBMs which may be applied to disparate sets of activities or users.

18. The computer program product of claim 15, wherein data of the user is received from one or more Internet-of-Things devices which monitored the user, as well as an environment of the user, and stored data relating to a physical or emotional state of the user in the context of the activity being performed by the user.

19. The computer program product of claim 15, wherein attributes of the UBM comprise an element from the group consisting of an activity type, a complexity of the activity, an importance of the activity to the user, a topic, a category, one or more sentiment coefficients of the user, a participation coefficient of the user, and a relative movement coefficient of the user.

20. The computer program product of claim 19, wherein the RCC of the user for the activity is calculated as a function of the complexity of the activity, the importance of the activity to the user, the one or more sentiment coefficients of the user, the participation coefficient of the user, and the relative movement coefficient of the user.
